(19) United States
(12) Patent Application Publication
(10) Pub. No.: US 2002/0078253 A1
(43) Pub. Date: Jun. 20, 2002

(54) Translation of digital contents based on receiving device capabilities

(76) Inventors: Gyorgy Szondy, Budapest (HU); Mika Leppinen, Woburn, MA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/739,798

(22) Filed: Dec. 20, 2000

(51) Int. Cl. G06F 9/44

(52) U.S. Cl. 709/315

(57) ABSTRACT

A method of and a system for translating digital contents based on the capabilities of a receiving device. When the receiving device sends a request for digital contents, the request includes identification of the type of receiving device. The content source or an intermediate translation component identifies the capabilities of the receiving device, such as whether the device is capable of providing color, graphics, sound, etc., and the size of the display screen on the receiving device. The content source or translation component then assembles a set of translation documents based on the identified capabilities and translates the digital contents in accordance with the assembled set. The translated contents is provided to the receiving device.

### FIELD OF THE INVENTION

The present invention pertains to the translation of digital contents for a receiving device, particularly a mobile receiving device such as a mobile telephone, a personal digital assistant, a palm pilot, or another Wireless Application Protocol (WAP) device.

### BACKGROUND OF THE INVENTION

Internet browsers generally are provided with content in a language such as eXtensible Markup Language (XML). Many receiving devices which want to receive content from an Internet browser are capable of processing XML content; however, many other receiving devices have capabilities different from those of the Internet browser. In particular, mobile devices such as mobile telephones frequently require WAP content, for example in a Wireless Markup Language (WML). The resulting need to adjust the content to a format compatible with the capabilities of the receiving devices has led to the development of languages such as eXtensible Stylesheet Language (XSL), Java, and PERL which allow the content to be translated for the receiving device using different translation documents which are selected in accordance with the capabilities of the receiving device. However, creation of the content in the desired format can necessitate the use of several different translation documents for the several different features of the digital content so as to provide those features in accordance with the capabilities of the receiving device. Some receiving devices are capable of providing a color display; others are not. Some receiving devices are capable of displaying graphics; others are not. Some have a sound capability; others do not. Different receiving devices have different screen sizes. Numerous other capabilities must be accommodated. Consequently, a full set of translation documents is needed to permit transformation of the content for the capabilities of the particular receiving device.

The number of different types of mobile receiving devices is quite large and is continuously growing. By “types of receiving devices” is meant whether the device is a mobile phone, a personal digital assistant, a palm pilot, or another WAP device, and the particular manufacturer, model, and version of the device. Thus, for example, any one manufacturer may have several models of mobile phones, with different versions of each model, and also several models of personal digital assistants, with different versions of each. Each of these is a different type of receiving device, and may have a different set of capabilities. The capabilities of the different types receiving devices can be quite varied and can change between different releases of the same model of device. As a consequence, the number of different combinations of capabilities, and so the number of different combinations of translation documents which it must be possible to provide, is quite large. Heretofore, a set of translation documents has been stored at the content source or at an intermediate location for each different type of receiving device. Thus, for example, a first set of translation documents is stored for a first type of receiving device, a second set is stored for a second type of receiving device, etc. Every time a new receiving device is introduced or an existing device modified, the content developer must create a set of translation documents for the capabilities of the device. It is very expensive to track the features of every new device and to prepare a set of translation documents specific to that device. In addition, the large number of sets of translation documents require a significant amount of memory at the translation location.

### SUMMARY OF THE INVENTION

Although there are a number of different types of mobile receiving devices, each type having a particular set of capabilities, the number of different types of capabilities is more limited. Thus, for example, a particular receiving device either has a color capability or it does not, either has a graphic capability or it does not, etc. There are only two possibilities as to each of these capabilities. Likewise, there is a limited number of screen sizes on the different types of receiving devices. However, there are a large number of types of receiving devices, each of which has particular combination of these capabilities. Devices can also be categorized to limit the number of capabilities, for example all small screen devices can show less than 3 lines.

The present invention is a method of and system for translating digital content for receiving devices based on the capabilities of the different receiving devices, rather than on the type of receiving device. In accordance with the present invention, when a request for content is received, the device that is to receive that content is identified, and the capabilities of that type of receiving device are determined. A set of translation documents is assembled based on the determined capabilities, rather than on the type of receiving device. The digital contents are then translated in accordance with the assembled set of translation documents, and the desired content is created and provided to the receiving device.

### BRIEF DESCRIPTION OF THE DRAWINGS

These and other aspects and advantages of the present invention are more apparent from the following detailed description and claims, particularly when considered in conjunction with the accompanying drawings. In the drawings:

FIG. 1 is a block diagram of a first embodiment of a system for translating digital contents in accordance with the present invention;

FIG. 2 is a flowchart of an embodiment of a method of translating digital contents in accordance with the present invention;

FIG. 3 is a block diagram of an embodiment of a translation unit suitable for use in the system of FIG. 1 or the system of FIG. 4 in accordance with the present invention; and

FIG. 4 is a block diagram of a second embodiment of a system for translating digital contents in accordance with the present invention.

### DETAILED DESCRIPTION OF PREFERRED EMBODIMENTS

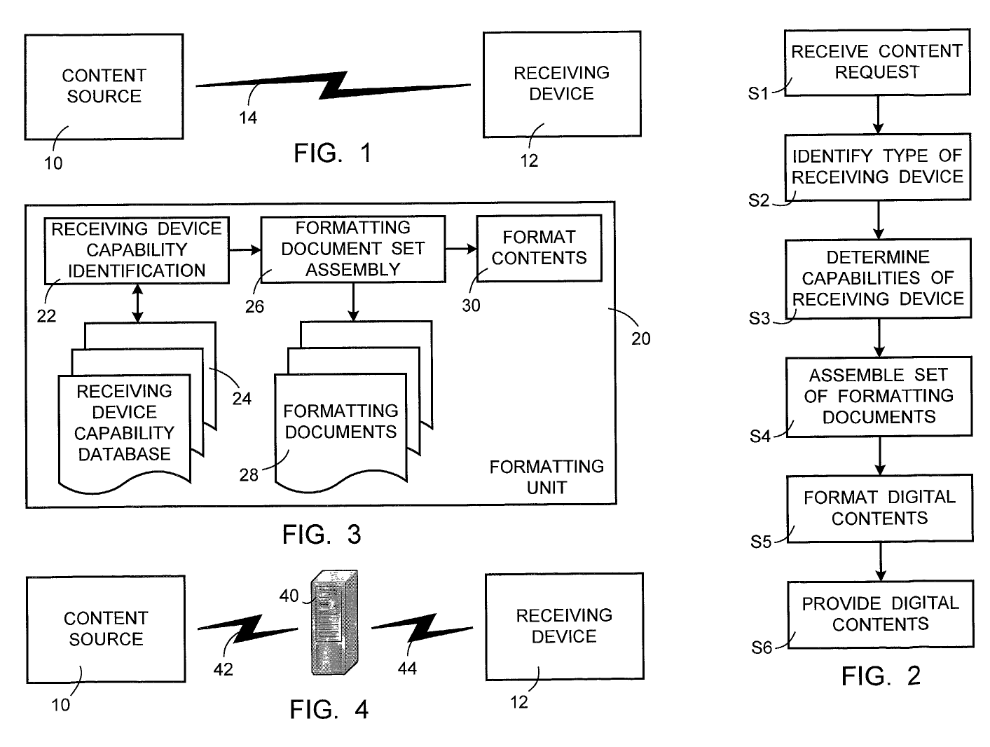

FIG. 1 is a block diagram of a first embodiment of a system for translation digital contents in accordance with the present invention. A content source 10 provides digital contents to a receiving device 12, for example by means of a wireless connection 14. Content source 10 might be a main frame computer, a personal computer, or any other source capable of providing digital contents. Receiving device 12 might be a wireless device such as a mobile telephone or a notebook or laptop computer having a wireless connection. The digital contents might be in any form, including text such as electronic books, newspapers, or e-mail, or including audio content such as music or video content such as a video game.

FIG. 2 is a flowchart of an embodiment of a method of translation digital contents in accordance with the present invention. FIG. 3 depicts a translation unit 20 which might be made up of a central processing unit (CPU) and a memory within content source 10. When receiving device 12 wishes to receive digital contents, the receiving device sends a request for the digital contents to content source 10. The request might include a header identifying receiving device 12 as a particular type of receiving device. Content source 10 receives the content request in a step S1, and then in a step S2 the CPU identifies the type of receiving device, for example from the header or from a specific pattern or substring in the name of the receiving device. In step S3, content source 10 determines the capabilities of the receiving device. By way of example, a receiving device capability identification section 22 within translation unit 20 might receive the identity of the type of receiving device on line 23 from elsewhere in the CPU, and access a receiving device capability database 24 to determine the capabilities of the type of receiving device identified from the header received in step S1. If for any reason the capabilities of the receiving device can not be determined, then a default set of capabilities may be used. In step S4 translation unit 20 assembles a set of translation documents appropriate for the capabilities of the receiving device as determined in step S3. This might be done by a translation document set assembly section 26 which selects translation documents from a database 28 of such documents. Each database 24 and 28 can be a look-up table, for example. Then in step S5 the digital contents are formatted. For example, a content translation section 30 within translation unit 20 might receive the digital contents from a contents memory 32 and receive the set of translation documents from translation document set assembly section 26, enabling content translation section 30 to translate the contents. In step S6, the translated digital contents are created and then provided on line 34 for transmission to receiving device 12.

Translation unit 20 might be within content source 10 of FIG. 1. Alternatively, as depicted in FIG. 4 receiving device 12 might be coupled to content source 10 by means of a server 40 which has a first wireless connection 42 to content source 10 and a second wireless connection 44 to receiving device 12. Translation unit 20 can then be in server 40, if desired.

Although the invention has been described with reference to preferred embodiments, various alterations, rearrangements, and substitutions could be made, and still the result would be within the scope of the invention. Thus, rather than storing the capabilities in a database such as database 24, the receiving device could transmit its capabilities along with the request for digital content. For example, the WAP specification includes a User Agent Profile (UA_PROF) under which the receiving device capabilities are received as a part of the request for contents. In any of its forms, the invention permits the translation of digital contents for a receiving device based on the capabilities of the receiving device.

What is claimed is:

1. A method of translating digital contents for a receiving device, said method comprising the steps of:
(a) identifying the receiving device;
(b) determining the capabilities of the identified receiving device;
(c) assembling a set for translation documents to translate the digital contents for the determined capabilities; and
(d) translating the digital contents, using the assembled set of translation documents.

2. A method as claimed in claim 1, further comprising the step of:
(e) creating an output document, utilizing the translated digital contents.

3. A method as claimed in claim 2, further comprising the step of:
(f) providing the output document.

4. A method as claimed in claim 1, wherein the digital contents are XML contents.

5. A method as claimed in claim 1, wherein step (b) comprises determining the capabilities based on a user-agent profile standard of the receiving device.

6. A method as claimed in claim 1, wherein step (b) comprises obtaining capabilities from a database of capabilities.

7. A method as claimed in claim 1, wherein step (b) comprises utilizing a set of default capabilities.

8. A method as claimed in claim 1, wherein step (c) comprises selecting each translation document of the set of translation documents from a plurality of translation documents.

9. A method as claimed in claim 1, wherein step (d) comprises performing an XSL transformation.

10. A method as claimed in claim 1, wherein step (d) comprises performing a Java transformation.

11. A method as claimed in claim 1, wherein step (d) comprises performing a PERL transformation.

12. A method as claimed in claim 1, further comprising before step (a) the step of receiving the digital contents.

13. An article, comprising a storage medium having instructions stored thereon, the instructions when executed controlling translation of digital contents for a receiving device by identifying the receiving device, determining the capabilities of the identified receiving device, assembling a set of translation documents to translate the digital contents for the determined capabilities, and translating the digital contents, using the assembled set of translation documents.

14. An article as claimed in claim 13, wherein the instructions when executed additionally create an output document.

15. An article as claimed in claim 14, wherein the instructions when executed additionally provide the output document.

16. An article as claimed in claim 13, wherein the instructions when executed determine the capabilities based on a user-agent profile standard of the receiving device.

17. An article as claimed in claim 13, wherein the instructions when executed determine the capabilities by obtaining capabilities from a database of capabilities.

18. An article as claimed in claim 13, wherein the instructions when executed determines the capabilities by utilizing a set of default capabilities.

19. An article as claimed in claim 13, wherein the instructions when executed select each translation document of the set of translation documents from a plurality of translation documents.

20. An article as claimed in claim 13, wherein the instructions when executed translate the digital contents by performing an XSL transformation.

21. An article as claimed in claim 13, wherein the instructions when executed translate the digital contents by performing an Java transformation.

22. An article as claimed in claim 13, wherein the instructions when executed translate the digital contents by performing an PERL transformation.

23. A system for translating digital contents for a receiving device, said system comprising:
means for identifying the receiving device;
means for determining the capabilities of the identified receiving device;
means for assembling a set of translation documents to translate the digital contents for the determined capabilities; and
means for translating the digital contents, using the assembled set of translation documents.

24. A system as claimed in claim 22, further comprising means for creating an output document, utilizing the translated document contents.

25. A system as claimed in claim 24, further comprising means for providing the output document.

26. A system as claimed in claim 23, wherein said determining means includes a user-agent profile standard of the receiving device.

27. A system as claimed in claim 23, further comprising a database of capabilities of receiving devices, and wherein said determining means comprises means for obtaining the capabilities from said database.

28. A system as claimed in claim 23, further comprising a set of default capabilities, and wherein said determining means comprises means for obtaining the capabilities from said set of default capabilities.
